(19) United States
(12) Patent Application Publication
(10) Pub. No.: US 2023/0186137 A1
(43) Pub. Date: Jun. 15, 2023

(54) Quantum Circuit Processing Method and Device on Quantum Chip, and Electronic Device

(71) Applicant: Beijing Baidu Netcom Science Technology Co., Ltd., Beijing (CN)

(72) Inventors: Xin WANG, Beijing (CN); Lijing JIN, Beijing (CN); Zhan YU, Beijing (CN); Chenghong ZHU, Beijing (CN); Xuanqiang ZHAO, Beijing (CN)

(21) Appl. No.: 18/164,334

(22) Filed: Feb. 3, 2023

(30) Foreign Application Priority Data
May 25, 2022 (CN) 202210587477.9

(51) Int. Cl. G06N 10/40; G06N 10/20

(52) U.S. Cl. CPC G06N 10/40; G06N 10/20

(57) ABSTRACT

The present disclosure provides a quantum circuit processing method and a quantum circuit processing device on a quantum chip, and an electronic device, and it relates to the field of quantum computing technology, in particular to the field of quantum circuit technology. The method includes: obtaining a first swap fidelity for measuring connectivity of the quantum chip, the first swap fidelity being determined in accordance with first information, the first information being used to represent a topological structure of the quantum chip, the topological structure indicating that the quantum chip includes at least two physical quantum bits, the first swap fidelity being used to represent an average state maintenance level of logic quantum bits obtained through analog exchanging quantum states of any two of the physical quantum bits; and performing quantum circuit processing on the quantum chip in accordance with the first swap fidelity.

### CROSS-REFERENCE TO RELATED APPLICATION

This application claims priority to Chinese Patent Application No. 202210587477.9 filed on May 25, 2022, the disclosure of which is incorporated in its entirety by reference herein.

### TECHNICAL FIELD

The present disclosure relates to the field of quantum computing technology, in particular to the field of quantum circuit technology, more particularly to a quantum circuit processing method and a quantum circuit processing device on a quantum chip, and an electronic device.

### BACKGROUND

Along with the development of the superconducting quantum computing technology and the micro-nano machining process, more and more quantum bits are integrated in a superconducting quantum chip, and the quantum chip is provided with a richer and more comprehensive structure.

Due to the tight coupling between the quantum bits in the superconducting quantum chip, connectivity between the quantum bits in the quantum chip is limited to some extent, i.e., usually a double-bit quantum gate, e.g., a controlled-NOT (CNOT) gate, is achieved merely between adjacent physical quantum bits, so it is impossible to execute a quantum algorithm (a logic quantum circuit) directly on a physical device.

Currently, quantum states of two physical quantum bits are usually swapped with each other through a swap gate, so that a logic quantum bit obtained after the swapping is mapped to a physical quantum bit for the double-bit quantum gate. In addition, the connectivity of the quantum chip is measured in accordance with the quantity of swap gates.

### SUMMARY

An object of the present disclosure is to provide a quantum circuit processing method and a quantum circuit processing device on a quantum chip, and an electronic device, so as to solve problems in the related art.

In a first aspect, the present disclosure provides in some embodiments a quantum circuit processing method on a quantum chip, including: obtaining a first swap fidelity for measuring connectivity of the quantum chip, the first swap fidelity being determined in accordance with first information, the first information being used to represent a topological structure of the quantum chip, the topological structure indicating that the quantum chip includes at least two physical quantum bits, the first swap fidelity being used to represent an average state maintenance level of logic quantum bits obtained through analog exchanging quantum states of any two of the physical quantum bits; and performing quantum circuit processing on the quantum chip in accordance with the first swap fidelity.

In a second aspect, the present disclosure provides in some embodiments a quantum circuit processing device on a quantum chip, including: a first obtaining module configured to obtain a first swap fidelity for measuring connectivity of the quantum chip, the first swap fidelity being determined in accordance with first information, the first information being used to represent a topological structure of the quantum chip, the topological structure indicating that the quantum chip includes at least two physical quantum bits, the first swap fidelity being used to represent an average state maintenance level of logic quantum bits obtained through analog exchanging quantum states of any two of the physical quantum bits; and a circuit processing module configured to perform quantum circuit processing on the quantum chip in accordance with the first swap fidelity.

In a third aspect, the present disclosure provides in some embodiments an electronic device, including at least one processor, and a memory in communication with the at least one processor and storing therein an instruction executed by the at least one processor. The instruction is executed by the at least one processor so as to implement the quantum circuit processing method in the first aspect.

In a fourth aspect, the present disclosure provides in some embodiments a non-transitory computer-readable storage medium storing therein a computer instruction. The computer instruction is executed by a computer so as to implement the quantum circuit processing method in the first aspect.

In a fifth aspect, the present disclosure provides in some embodiments a computer program product including a computer program. The computer program is executed by a processor so as to implement the quantum circuit processing method in the first aspect.

According to the embodiments of the present disclosure, it is able to solve the problem in the related art where it is impossible to measure the connectivity of the quantum chip in a comprehensive and accurate manner, i.e., it is able to quantize the connectivity of the quantum chip in a comprehensive and accurate manner, thereby to improve the operating accuracy of the quantum circuit, i.e., a quantum algorithm.

It should be understood that, this summary is not intended to identify key features or essential features of the embodiments of the present disclosure, nor is it intended to be used to limit the scope of the present disclosure. Other features of the present disclosure will become more comprehensible with reference to the following description.

### BRIEF DESCRIPTION OF THE DRAWINGS

The following drawings are provided to facilitate the understanding of the present disclosure, but shall not be construed as limiting the present disclosure. In these drawings,

FIG. 1 is a flow chart of a quantum circuit processing method on a quantum chip according to a first embodiment of the present disclosure;

FIG. 2 is a schematic view showing a topological structure of a superconducting quantum circuit;

FIG. 3 is another schematic view showing the topological structure of the superconducting quantum circuit;

FIG. 4 is yet another schematic view showing the topological structure of the superconducting quantum circuit;

FIG. 5 is a schematic view showing a quantum circuit processing device on a quantum chip according to a second embodiment of the present disclosure; and

FIG. 6 is a block diagram of an exemplary electronic device according to one embodiment of the present disclosure.

### DETAILED DESCRIPTION

In the following description, numerous details of the embodiments of the present disclosure, which should be deemed merely as exemplary, are set forth with reference to accompanying drawings to provide a thorough understanding of the embodiments of the present disclosure. Therefore, those skilled in the art will appreciate that modifications or replacements may be made in the described embodiments without departing from the scope and spirit of the present disclosure. Further, for clarity and conciseness, descriptions of known functions and structures are omitted.

### First Embodiment

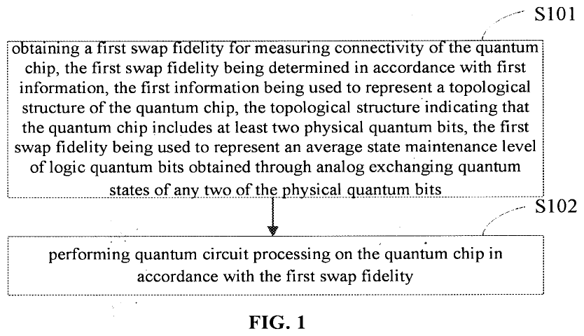

As shown in FIG. 1, the present disclosure provides in this embodiment a quantum circuit processing method on a quantum chip, which includes the following steps.

Step S101 comprises obtaining a first swap fidelity for measuring connectivity of the quantum chip. The first swap fidelity is determined in accordance with first information, wherein the first information is used to represent a topological structure of the quantum chip, the topological structure indicating that the quantum chip includes at least two physical quantum bits. The first swap fidelity is used to represent an average state maintenance level of logic quantum bits obtained through analog exchanging quantum states of any two of the physical quantum bits.

In this embodiment of the present disclosure, the quantum circuit processing method on the quantum chip relates to the field of quantum computing technology, in particular to the field of quantum circuit technology, and it is widely applied to a quantum algorithm design scenario. The quantum circuit processing method on the quantum chip in this embodiment of the present disclosure is executed by a quantum circuit processing device on the quantum chip. The quantum circuit processing device on the quantum chip is configured in any electronic device so as to implement the quantum circuit processing method on the quantum chip. The electronic device is either a server or a terminal device, which will not be particularly defined herein.

As a logical necessity for a chip size to break through a classical physical limit and an iconic technology in a post-Moore era, quantum computing has attracted more and more attention, and it has developed very fast at an application level, an algorithm level and a hardware level.

The implementation of the quantum algorithm and application is highly dependent on the development and progress of the quantum hardware. The quantum hardware is implemented in various technical solutions, e.g., superconducting circuits, ion traps, optical quantum systems, etc. Due to excellent extensibility and a mature semiconductor process, the superconducting circuit is currently considered as one of the most promising technical approaches.

In the embodiments of the present disclosure, the quantum chip refers to a superconducting quantum chip. Due to the tight coupling between the quantum bits in the superconducting quantum chip, connectivity between the quantum bits in the superconducting quantum chip is limited to some extent, i.e., usually a double-bit quantum gate, e.g., a CNOT gate, is achieved merely between adjacent physical quantum bits.

Usually, the quantum algorithm is presumed to achieve the double-bit quantum gate between any quantum bits, so due to the limitation on the connectivity between the quantum bits in the superconducting chip, it is impossible for the quantum algorithm (logic quantum circuit) to be directly executed by a physical device, e.g., the superconducting quantum chip.

In order to solve the above-mentioned problem, a logic quantum bit needs to be mapped to a physical quantum bit through a qubit mapping algorithm, so as to achieve the double-bit quantum gate between any two logic quantum bits. The physical quantum bit refers to a quantum bit integrated on the superconducting quantum chip itself, and a quantum bit obtained through mapping content, i.e., a quantum state, to the physical quantum bit is just the logic quantum bit.

The qubit mapping algorithm is mainly used to swap the quantum states of two adjacent physical quantum bits in the quantum chip through a swap gate, so as to exchange the quantum states of different physical quantum bits in the quantum chip. In this way, the logic quantum bits obtained through exchanging the content, i.e., the quantum state, are mapped to the physical quantum bits between which the double-bit quantum gate is achieved. However, due to a swapping operation in the qubit mapping algorithm, more noise is introduced, and the introduced noise may probably lead to a wrong answer calculated through the quantum algorithm.

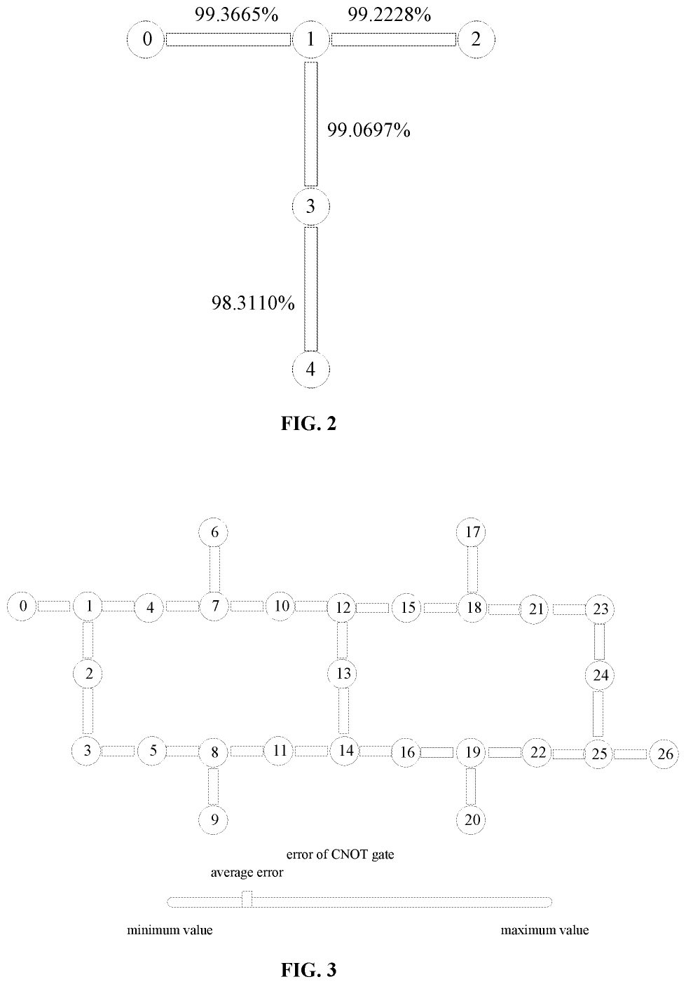

FIG. 2 is a schematic view showing a topological structure of the superconducting quantum circuit. As shown in FIG. 2, the superconducting quantum circuit includes five physical quantum bits, represented by vertices 0, 1, 2, 3 and 4 respectively, and the topological structure is expressed as {Q₀, Q₁, Q₂, Q₃, Q₄}. A line connecting vertices i and j represents that the double-bit quantum gate may be achieved between a physical quantum bit i and a physical quantum bit j. In the superconducting quantum circuit, an operation of the double-bit quantum gate is allowed to be performed between every two physical quantum bits, i.e., a set of positions where the operation of the double-bit quantum gate is allowed is P=[[0,1], [1,0], [1,2], [2,1], [1,3], [3,1], [3,4], [4,3]]. In order to perform the operation of the double-bit quantum gate between the quantum bits not adjacent to each other, the quantum states of two adjacent physical quantum bits are swapped with each other through the swap gate, i.e., through at least one swapping operation, it is able to exchange the quantum states between different physical quantum bits, thereby to map the logic quantum bits to the physical quantum bits between which the double-bit quantum gate is achieved.

When the double-bit quantum gate needs to be achieved between Q₀ and Q₄, quantum states of Q₀ and Q₄ are swapped to two adjacent physical quantum bits through the swap gate. For example, as one mapping scheme, the quantum state of Q₀ is exchanged with the quantum state of Q₁, and then exchanged with a quantum state of Q₃, so that a logic quantum bit mapped to Q₃ is adjacent to Q₄, and thereby the double-bit quantum gate is achieved between Q₀ and Q₄. Due to a series of swapping operations, an error may be introduced, and the more the swapping operations, the larger the error.

Through improving the connectivity of the quantum chip itself, it is possible to reduce quantity of swap gates, thereby reducing the noise introduced due to the swapping operations. Hence, it is very important to comprehensively and accurately measure the connectivity of the quantum chip.

In the related art, the connectivity of the quantum chip is measured in accordance with an average quantity of swap gates, i.e., through calculating the average quantity of swap gates between any two quantum bits in the quantum chip for the double-bit quantum gate operation. In the embodiments of the present disclosure, an average swap fidelity is used to measure the connectivity of the quantum chip, so as to determine whether the superconducting quantum chip has an ability to execute the quantum algorithm with a smaller error.

A fidelity is used to measure a state maintenance level of the quantum state in the mapping process or a size of the introduced error, and the average swap fidelity refers to an average fidelity of the quantum states of any two physical quantum bits after the swapping in the case that the error is introduced due to the swap gate, i.e., an average state maintenance level of the logic quantum bits obtained after the analog exchanging of the quantum stages of any two physical quantum bits in the quantum chip.

Through the average swap fidelity, it is able to comprehensively and accurately measure the connectivity of the quantum chip. For example, a minimum quantity of swap gates is 1 for mapping a logic quantum bit A in the quantum chip to a physical quantum bit B, and a swap fidelity for this swap path is 0.6. In addition, there is another swap path where the quantity of swap gates is 2 for mapping the logic quantum bit A to the physical quantum bit B, but a swap fidelity is 0.9.

The average quantity of swap gates calculated in accordance with a shortest path does not completely reflect the connectivity of the quantum chip, but when the qubit mapping is performed using the swap path with the swap fidelity of 0.9, the state maintenance level of the quantum state of the logic quantum bit is larger, i.e., fewer errors are introduced. Hence, through the average swap fidelity, it is able to comprehensively and accurately measure the connectivity of the quantum chip, thereby to determine whether the superconducting quantum chip has an ability to execute the quantum algorithm with a smaller error.

It should be appreciated that, in the case that two physical quantum bits are adjacent to each other, the exchanging of the quantum states of the two physical quantum bits refers to the swapping of the quantum states of the two physical quantum bits, e.g., the quantum state of Q₀ is swapped with the quantum state of Q₁. In the case that two physical quantum bits are not adjacent to each other, the exchanging of the quantum states of the two physical quantum bits refers to the swapping of the quantum states of the physical quantum bits adjacent to the two physical quantum bits through at least two swapping operations until the quantum states of the two physical quantum bits are swapped with each other, e.g., the quantum state of Q₀ is swapped with the quantum state of Q₁, and then the quantum state of Q₁ is swapped with the quantum state of Q₃, so as to swap the quantum state of Q₀ with the quantum state of Q₃, thereby to map the quantum state of Q₀, i.e., the logic quantum bit, to Q₃.

The first swap fidelity is determined in accordance with the first information, the first information is used to represent the topological structure of the quantum chip, and the topological structure indicates that the quantum chip includes at least two physical quantum bits. As shown in FIG. 2, the topological structure indicates that the quantum chip includes five physical quantum bits. The first information is represented by a structural graph G, and G is represented by an n*n adjacency matrix, where n represents the quantity of physical quantum bits in the quantum chip, G=(w_{i,j})_{n×n}, and w_{i,j} represents an error for a first double-bit quantum gate, e.g., a CNOT gate, between two nodes, i.e., two physical quantum bits (the error is equal to a fidelity obtained when the first double-bit quantum gate is used between the physical quantum bits subtracted from 1). When the two nodes are not adjacent to each other, w_{i,j}=0.

The first swap fidelity is determined merely in accordance with the first information, or is determined in accordance with the first information and second information, and the second information includes a target error for the first double-bit quantum gate between every two adjacent physical quantum bits. The target error refers to an error introduced due to the first double-bit quantum gate between two adjacent physical quantum bits, and it is equal to a fidelity of the first double-bit quantum gate between the two adjacent physical quantum bits subtracted from 1.

The first double-bit quantum gate is a CNOT gate, or any other double-bit quantum gate, and different hardware devices have different primitive double-bit quantum gates, which will not be particularly defined herein.

As shown in FIG. 2, a line connecting the vertices i and j represents a fidelity of the CNOT gate between the physical quantum bits i and j.

In a possible embodiment of the present disclosure, the swap fidelity of a first swapping path for the quantum states of every two physical quantum bits in the quantum chip is determined in accordance with the topological structure of the quantum chip, and the first swapping path is a swapping path with a largest swap fidelity in swapping paths for the quantum states of the two physical quantum bits. The swap fidelity is determined in accordance with the error introduced due to the swapping operation, and the swap fidelities of the first swapping paths for the quantum states of every two physical quantum bits are averaged to obtain the first swap fidelity.

The error introduced due to the swapping operation is determined in accordance with the fidelity of the swap gate, and when the swap gates are implemented in different ways, the errors introduced due to the swapping operation may be different too. When the swap gates are implemented through a plurality of CNOT gates, e.g., three CNOT gates, and each CNOT gate is achieved between two adjacent physical quantum bits, the error introduced due to the swapping operation is determined in accordance with the target error, i.e., the first swap fidelity is determined in accordance with the first information and the second information.

The first swap fidelity may be determined by the quantum circuit processing device on the quantum chip itself, or the quantum circuit processing device on the quantum chip may receive the first swap fidelity from any other electronic device.

Step S102 of the method includes performing quantum circuit processing on the quantum chip in accordance with the first swap fidelity.

In this step, a corresponding application is performed in accordance with the first swap fidelity. To be specific, the quantum circuit processing is performed on the quantum chip in accordance with the first swap fidelity.

In addition, when the first swap fidelity is smaller than a predetermined threshold, the quantum chip is re-designed to modify a hardware structure of the quantum chip, so as to improve the connectivity of the quantum chip.

The predetermined threshold is set according to the practical need. For example, when the quantum circuit is of a complex structure or design accuracy of the quantum circuit is highly demanded, usually the quantum chip is required to have better connectivity. At this time, the predetermined threshold is provided with a large value, so as to enable the quantum chip to have an ability to execute the quantum algorithm with a smaller error.

In this embodiment of the present disclosure, the first swap fidelity for measuring the connectivity of the quantum chip is obtained, and then the quantum circuit processing is performed on the quantum chip in accordance with the first swap fidelity. As a result, it is able to comprehensively and accurately measure the connectivity of the quantum chip in accordance with the first swap fidelity, and perform the quantum circuit processing on the quantum chip in accordance with the first swap fidelity, thereby to improve the operating accuracy of the quantum circuit, i.e., the quantum algorithm.

In addition, through the first swap fidelity, it is able to accurately measure the connectivity of the quantum chip in a universal manner, e.g., a solid-state superconducting quantum chip with various topological structures, and guide the design of the quantum chip and the implementation of the quantum algorithm on a noise-containing quantum chip.

In a possible embodiment of the present disclosure, Step S101 specifically includes: obtaining the first information; determining a second swap fidelity of a first swapping path for quantum states of every two physical quantum bits, the first swapping path being a swapping path with a maximum swap fidelity in swapping paths for the quantum states of the two physical quantum bits, the second swap fidelity being used to represent a state maintenance level of logic quantum bits obtained through analog exchanging the quantum states of the two physical quantum bits in accordance with the first swapping path; and averaging the second swap fidelities to obtain the first swap fidelity.

In the embodiments of the present disclosure, the first information pre-stored in the quantum circuit processing device on the quantum chip is obtained, or the first information is inputted by a user or received from any other electronic device, which will not be particularly defined herein.

The second swap fidelity of the first swapping path for the quantum states of every two physical quantum bits in the quantum chip is determined in accordance with the topological structure of the quantum chip, the first swapping path is a swapping path with the maximum swap fidelity in swapping paths for the quantum states of the two physical quantum bits, and the swap fidelity is determined in accordance with an error introduced by the swapping operation.

In a possible embodiment of the present disclosure, with respect to every two physical quantum bits, all swapping paths for the two physical quantum bits are traversed in accordance with the topological structure of the quantum chip, the swap fidelity of each swapping path is calculated, and the swapping path with the maximum swap fidelity is determined as the first swapping path.

Correspondingly, the maximum swap fidelity is just the second swap fidelity. The second swap fidelity is used to represent a maximum state maintenance level of the logic quantum bits obtained through exchanging the quantum states of the two physical quantum bits, i.e., when the quantum states of the two physical quantum bits are exchanged through the first swapping path, the error introduced by the swapping operation is minimum.

In another possible embodiment of the present disclosure, the second swap fidelity of the first swapping path for the quantum states of every two physical quantum bits is determined in accordance with the topological structure of the quantum chip and a target error for a first double-bit quantum gate between every two adjacent physical quantum bits in the quantum chip.

Then, the second swap fidelities of the first swap path for the quantum states of every two physical quantum bits are averaged to obtain the first swap fidelity. For example, the quantum chip includes five physical quantum bits, and there are four second swap fidelities with respect to each physical quantum bit. Correspondingly, a 4*5 swap fidelity matrix is formed, and all numerical values in the swap fidelity matrix are added, and a resultant sum is divided by 20, so as to obtain the first swap fidelity.

In the embodiments of the present disclosure, the first information is obtained, the second swap fidelity of the first swapping path for the quantum states of every two physical quantum bits is determined, and then the second swap fidelities are averaged to obtain the first swap fidelity. In this way, it is able to determine the first swap fidelity in accordance with the first information.

In a possible embodiment of the present disclosure, the determining the second swap fidelity of the first swap path for the quantum states of every two physical quantum bits in accordance with the first information includes: obtaining second information, the second information including a target error for a first double-bit quantum gate between every two adjacent physical quantum bits; and determining the second swap fidelity in accordance with the first information and the second information.

In the embodiments of the present disclosure, when determining the second swap fidelity, the target error for the first double-bit quantum gate between every two adjacent physical quantum bits is taken into consideration. The first double-bit quantum gate is a CNOT gate or any other double-bit quantum gate, and different hardware devices have different primitive double-bit quantum gates, which will not be particularly defined herein.

To be specific, noises occur in physical hardware, and there is a certain error between a result of the quantum algorithm and a predetermined result due to the double-bit quantum gates between different physical quantum bits. Hence, the target error for the first double-bit quantum gate between every two adjacent physical quantum bits is taken into consideration. In addition, the mapping of any two quantum bits is achieved through several swap gates, and each swap gate is achieved through the first double-bit quantum gate.

For example, the first double-bit quantum gate is a CNOT gate, and the swap gate is achieved through three CNOT gates. It should be appreciated that, the above-mentioned conversion relationship between the swap gate and the first double-bit quantum gate is merely for illustrative purposes, and different hardware has different primitive double-bit gates, and the swap gate is achieved in different ways.

Further, the error introduced by the swapping operation is determined in accordance with the fidelity of the swap gate. When the swap gate is achieved through the first double-bit quantum gate, e.g., a plurality of CNOT gates (three CNOT gates, for example) and the first double-bit quantum gate is achieved between every two physical quantum bits, the error introduced by the swapping operation is determined in accordance with the target error, i.e., the swap fidelity is determined in accordance with the topological structure of the quantum chip and the target error, so as to determine the second swap fidelity in a more accurate manner.

FIG. 3 is another schematic view showing the topological structure of the superconducting quantum chip. As shown in FIG. 3, the superconducting quantum chip includes 27 physical quantum bits, where each circle represents a physical quantum bit, and a rectangle between adjacent circles represents that the two physical quantum bits are coupled to each other through the CNOT gate. The topological structure of the superconducting quantum chip and an error of the CNOT gate are taken as an input, so as to calculate an average swap fidelity of the superconducting quantum chip, i.e., the first swap fidelity, thereby to intuitively measure the connectivity of the superconducting quantum chip.

In the 27 physical quantum bits, errors of the CNOT gates between every two physical quantum bits may be different. As shown in FIG. 3, the errors of the CNOT gates have a maximum value and a minimum value, and an average error of the CNOT gates between any two physical quantum bits is calculated in accordance with the errors of the CNOT gates. Correspondingly, when designing the quantum circuit, the CNOT gate may be avoided as much as possible to be executed through connection paths between the quantum bits with poor quality (i.e., the errors of the CNOT gates are greater than the average error of the CNOT gates).

In a possible embodiment of the present disclosure, the determining the second swap fidelity in accordance with the first information and the second information includes: obtaining a first set and a second set, the first set including a physical quantum bit as a start node of the swap path, the physical quantum bit as the start node being any physical quantum bit in at least two physical quantum bits, the second set including physical quantum bits in the at least two physical quantum bits other than the first set; selecting each physical quantum bit adjacent to a first physical quantum bit in the second set in accordance with the topological structure, the first physical quantum bit being a physical quantum bit in the first set; calculating each first weight between the first physical quantum bit and an adjacent physical quantum bit in accordance with the target error; and determining the second swap fidelity of the first swapping path for quantum states of the physical quantum bit as the start node to a second physical quantum bit in accordance with a second weight, the second weight being a minimum weight in the first weights, the second physical quantum bit being a physical quantum bit corresponding to the second weight.

In the embodiments of the present disclosure, in the case that the first information and the second information have been obtained, e.g., in the case that a structural graph G of the quantum chip is inputted and indicates that the quantum chip includes n number of physical quantum bits {Q₁ . . . Qₙ}, the first set and the second set are determined in accordance with the physical quantum bits in the quantum chip. To be specific, any physical quantum bit in the quantum chip, e.g., Qᵢ, is set as a start node and placed in to the first set S, and at the beginning, S={Qᵢ}. The other physical quantum bits are placed into the second set T, and T={Q₁ . . . Qₙ}/Qᵢ.

An auxiliary matrix D is introduced, and each element represents an initial weight for mapping the current start node to the other physical quantum bit, and an error introduced when the current start node is mapped to the other physical quantum bit is determined in accordance with the initial weight. For each physical quantum bit Qⱼ in T, when there is a line connecting Qᵢ and Qⱼ, Dⱼ is equal to a weight w_{i,j} on the line (i.e., a target error for a first double-bit quantum gate between Qᵢ and Qⱼ). The line is marked as a swapping path between Qᵢ and Qⱼ. Otherwise, Dⱼ is set as being infinitely great, i.e., ∞.

Each physical quantum bit adjacent to the first physical quantum bit is selected in the second set in accordance with the topological structure of the quantum chip, i.e., a set V of vertices each having a line connecting a corresponding vertex in S is selected in T, and the set V includes the physical quantum bits adjacent to the first physical quantum bit.

Taking FIG. 3 as an example, a physical quantum bit 0 is selected as the start node. During the section for the first time, a physical quantum bit 1 is selected in accordance with the topological structure of the quantum chip, and then a first weight between the first physical quantum bit, i.e., the physical quantum bit 0, and the adjacent physical quantum bit, i.e., the physical quantum bit 1, is calculated in accordance with a target error of a first double-bit quantum gate, e.g., a CNOT gate, between the physical quantum bit 0 and the physical quantum bit 1.

During the selection for the second time, the first set includes the physical quantum bit 0 and the physical quantum bit 1. A physical quantum bit 2 and a physical quantum bit 4 are selected in accordance with the topological structure of the quantum chip. First weights between the first physical quantum bit and the adjacent physical quantum bits are calculated in accordance with target errors of first double-bit quantum gates, e.g., CNOT gates, between the physical quantum bit 1 and the physical quantum bit 2 and between the physical quantum bit 1 and the physical quantum bit 4. The first weights include two values, i.e., the first weight between the physical quantum bit 1 and the physical quantum bit 2 and the first weight between the physical quantum bit 1 and the physical quantum bit 4.

The first weight between the first physical quantum bit and the adjacent physical quantum bit is calculated through Score=−log(w_{s,v}), s ∈ S, v ∈ V (1), where Score represents the first weight, and w_{s,v}, represents a target error between a vertex s in the first set S and a vertex v in the set V.

Correspondingly, the second swap fidelity of the first swapping path for the quantum states of the physical quantum bit as the start node to the vertex v (i.e., the second physical quantum bit) corresponding to the second weight is determined in accordance with the minimum weight of the first weights (i.e., the second weight).

To be specific, the auxiliary matrix D is updated in accordance with the second weight. For example, when the second weight is smaller than a weight in the auxiliary matrix D for mapping the start node to the second physical quantum bit, the weight in the auxiliary matrix D is updated with the second weight, otherwise the auxiliary matrix D is not updated. For another example, when there is a plurality of swapping path for mapping the start node to the second physical quantum bit, a third weight of each swapping path for the quantum sates of the physical quantum bit as the start node to the second physical quantum bit is determined in accordance with the second weight, i.e., there is a plurality of third weights. At this time, the auxiliary matrix D is updated in accordance with a minimum weight in the third weights, i.e., a fourth weight.

In the case that the auxiliary matrix D has been updated, each weight in the auxiliary matrix D is a minimum weight for mapping the physical quantum bit as the start node to the other physical quantum bit. Three CNOT gates need to be used for an operation of the swap gate, so the second swap fidelity of the first swapping path between the physical quantum bit as the start node and the second physical quantum bit is calculated through F(Qᵢ, Qₜ)=(e^{-D}^{ₜ})³ (2), where F(Qᵢ, Qₜ) represents the second swap fidelity, (⋅)³ represents that three CNOT gates need to be used for an operation of the swap gate, and Dₜ represents a weight in the auxiliary matrix D for mapping the physical quantum bit as the start node to a physical quantum bit t.

In the embodiments of the present disclosure, the first set and the second set are obtained, each physical quantum bit adjacent to the first physical quantum bit is selected in the second set in accordance with the topological structure, the first weight between the first physical quantum bit and each adjacent physical quantum bit is calculated in accordance with the target error, and the second swap fidelity of the first swapping path for the quantum states of the physical quantum bit as the start node to the second physical quantum bit is determined in accordance with the second weight. In this way, it is able to determine the second swap fidelity of the first swapping path for the quantum states of two physical quantum bits in accordance with the topological structure of the quantum chip and the target error.

In a possible embodiment of the present disclosure, the determining the second swap fidelity in accordance with the first information and the second information further includes: removing the second physical quantum bit from the second set; adding the second physical quantum bit into the first set; and in the case that the updated second set is not an empty set, determining the second swap fidelity of the first swapping path for quantum states of the physical quantum bit as the start node to a third physical quantum bit in accordance with the topological structure and the target error, the third physical quantum bit being a physical quantum bit in the updated second set.

Further, in the case that the second weight has been determined, the physical quantum bit corresponding to the second weight, i.e., the second physical quantum bit, is removed from the second set, and added into the first set.

In the case that the updated second set T is not an empty set, i.e., in the case that the first set S does not include all physical quantum bits in the quantum chip, it means that the second swap fidelity of the first swapping path for the quantum states of the physical quantum bit as the start node to the third physical quantum bit further needs to be determined, and the third physical quantum bit is a physical quantum bit in the quantum chip to which the physical quantum bit as the start node is not mapped. In this way, it is able to calculate the second swap fidelity of the first swapping path for the quantum states of the physical quantum bit as the start node to any other physical quantum bit.

The second swap fidelity of the first swapping path for the quantum states of the physical quantum bit as the start node to the third physical quantum bit may be determined in a same way as that for determining the second swap fidelity of the first swapping path for the quantum states of the physical quantum bit as the start node to the second physical quantum bit, which will not be particularly defined herein.

In the case that the updated second set T is an empty set, i.e., in the case that the first set S includes all the physical quantum bits in the quantum chip, the first set and the second set are emptied, another physical quantum bit is used as the start node and added into the first set, and the other physical quantum bits are added into the second set. Some steps of determining the second swap fidelity in accordance with the first set and the second set are repeated until the second swap fidelity of the first swapping path for the quantum states of every two physical quantum bits in the quantum chip has been calculated.

In a possible embodiment of the present disclosure, the determining the second swap fidelity of the first swapping path for the quantum states of the physical quantum bit as the start node to the second physical quantum bit in accordance with the second weight includes: determining third weights for swapping paths for the quantum states of the physical quantum bits as the start node to the second physical quantum bit in accordance with the second weight; and determining the second swap fidelity of the first swapping path in accordance with a fourth weight and a conversion relationship between the first double-bit quantum gate and the swap gate, the fourth weight being a minimum weight of the third weights, the first swapping path being a swapping path corresponding to the fourth weight, the second swap fidelity being in inverse proportion to the fourth weight, the swap gate being used to exchange the quantum states of the two physical quantum bits.

In the embodiments of the present disclosure, the second weight is a weight between the first physical quantum bit and an adjacent physical quantum bit.

In a possible embodiment of the present disclosure, when the physical quantum bit as the start node is adjacent to the second physical quantum bit, the third weight is just the second weight. During the implementation, the auxiliary matrix D is updated in accordance with the second weight. The first swapping path between the physical quantum bit as the start node and the second physical quantum bit is recorded.

In another possible embodiment of the present disclosure, when the physical quantum bit as the start node is not adjacent to the second physical quantum bit and there is one swapping path between the physical quantum bit as the start node and the second physical quantum bit, the swapping path is just the first swapping path. The third weight between the physical quantum bit as the start node and the second physical quantum bit is calculated in accordance with the first swapping path and the second weight, and the auxiliary matrix D is updated in accordance with the third weight. The first swapping path between the physical quantum bit as the start node and the second physical quantum bit is recorded.

In yet another possible embodiment of the present disclosure, when the physical quantum bit as the start node is not adjacent to the second physical quantum bit and there is a plurality of swapping paths between the physical quantum bit as the start node and the second physical quantum bit, the third weights for the swapping paths for the quantum states of the physical quantum bit as the start node and the second physical quantum bit are determined in accordance with the second weight, and the auxiliary matrix D is updated in accordance with a minimum one of the third weights, i.e., the fourth weight. The first swapping path between the physical quantum bit as the start node and the second physical quantum bit is recorded, and the first swapping path is a swapping path corresponding to the fourth weight.

It should be appreciated that, as a timing for updating the auxiliary matrix D, the weights are compared with each other when the second physical quantum bit is added into the first set, i.e., when the vertex v in the set V is added into the first set, so as to update the weight in the auxiliary matrix D to be a minimum weight. In this way, it is able to find the first swapping path with a maximum swap fidelity, i.e., the swapping path with best connectivity.

In the case that the auxiliary matrix D has been updated, the second swap fidelity of the first swapping path is determined in accordance with the fourth weight (Dₜ) and the conversion relationship between the first double-bit quantum gate and the swap gate (e.g., three CNOT gates need to be used by the swap gate), as expressed in the above formula (2).

In the embodiments of the present disclosure, the third weights for the swapping paths for the quantum states of the physical quantum bit as the start node to the second physical quantum bit are determined in accordance with the second weight, the second swap fidelity of the first swapping path is determined in accordance with the fourth weight and the conversion relationship between the first double-bit quantum gate and the swap gate, and the fourth weight is a minimum weight of the third weights. In this way, it is able to determine the second swap fidelity of the first swapping path for the quantum states of every two physical quantum bits.

A process of determining the first swap fidelity will be described hereinafter in details.

Step 1: a structural graph G of the quantum chip including n physical quantum bits {Q₁ . . . Qₙ} is inputted. G is expressed by an n*n adjacency matrix, and G=(w_{i,j})_{n×n}, where w_{i,j} represents an error of a CNOT gate used between two nodes. When the two nodes are not adjacent to each other, w_{i,j}=0.

Step 2: any physical quantum bit in a physical quantum bits on hardware is extracted as a start node S={Qᵢ}, and the following operations start to be executed between the start node and the remaining physical quantum bits T={Q₁ . . . Qₙ}/Qᵢ.

Step 3: an auxiliary matrix D is introduced. Each element in the auxiliary matrix represents an initial weight for mapping a current start node to the other physical quantum bit, and an error introduced when the current start node is mapped to the other physical quantum bit is determined in accordance with the initial weight. For each physical quantum bit Qⱼ in T, when there is a line connecting Qᵢ and Qⱼ, Dⱼ is equal to a weight w_{i,j} on the line, and the line is marked as a swapping path between Qᵢ and Qⱼ. Otherwise, Dⱼ is set as being infinitely great, i.e., ∞.

Step 4: a set V of vertices each having a line connecting a corresponding vertex in S is selected in T, weight scores are calculated sequentially through Score=−log(w_{s,v}), s ∈ S, v ∈ V, and a vertex v with a minimum weight score is removed from T and moved into S.

Step 5: when the vertex V with the minimum weight score is added into S and a weight of Qᵢ to v is reduced, a value of Dᵥ in the auxiliary matrix is updated as a smaller one, and meanwhile the swapping path between Qᵢ and v is updated.

Step 6: the above steps 4 and 5 are repeated until S includes all the physical quantum bits {Q₁ . . . Qₙ}.

Step 7: the minimum weight stores for the start node Qᵢ to the other physical quantum bits Qₜ in the auxiliary matrix D are extracted, and a swap fidelity is calculated through F(Qᵢ, Qₜ)=(e^{-D}^{ₜ})³, where e is used to convert the weight score into the fidelity, and (⋅)³ represents that three CNOT gates need to be used for an operation of the swap gate.

Step 8: all the physical quantum bits {Q₁ . . . Qₙ} are set as the start node sequentially, and the steps 3 to 7 are repeated until an optimum fidelity F(Qᵢ, Qⱼ) for the mapping between any two physical quantum bits i and j is obtained.

Step 9: a sum of the optimum swap fidelities, i.e., the second swap fidelities, for the mapping between any two physical quantum bits is calculated, and then the sum is divided by n(n−1) to obtain the first swap fidelity, i.e., the average swap

$$fidelity = \frac{{\sum }_{i = 1}^{n} {\sum }_{j = 1}^{n} F ( {Q}_{i} , {Q}_{j} )}{n ( n - 1 )} .$$

Correspondingly, the average swap fidelity is outputted, and meanwhile the optimum swap fidelity for exchanging the quantum states of every two physical quantum bits and the corresponding swapping path in the above-mentioned process are outputted in the form of a table. In this way, the outputted swapping path provide guidance on the subsequently-designed quantum circuit or circuit mapping.

In this instance, the swap fidelity is introduced to measure the connectivity, and the optimum swapping path is found with the fidelity as a reference, so as to calculate the average swap fidelity of the quantum chip, thereby to measure the connectivity of the quantum chip and provide a highly practical measurement method on the quantum chip. In addition, the outputted optimum swap path provides guidance on the implementation of the quantum algorithm on the quantum chip, and facilitates the subsequently-designed quantum circuit and circuit mapping, so it is able to improve the practicability remarkably.

In a possible embodiment of the present disclosure, the quantum circuit processing method further includes obtaining a first swapping path for quantum states of every two physical quantum bits, the first swapping path being a swapping path with a maximum swap fidelity in swapping paths for the quantum states of the two physical quantum bits. Step S102 specifically includes exchanging the quantum states of different physical quantum bits on the quantum chip in accordance with the first swap path, so as to map the logic quantum bit to the physical quantum bit to obtain the quantum circuit.

In the embodiments of the present disclosure, the first swapping path is a swapping path corresponding to the maximum swap fidelity. In the process of determining the second swap fidelity, the first swapping path for the quantum states of every two physical quantum bits is recorded, i.e., the swapping path corresponding to the second swap fidelity is determined as the first swapping path.

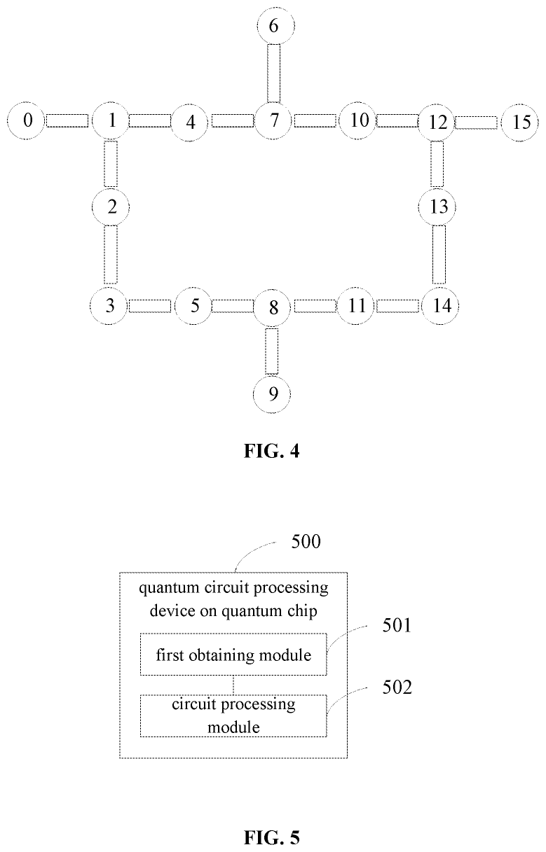

The first swapping path provides guidance on the implementation of the quantum algorithm, i.e., the logic quantum circuit, on the quantum chip. FIG. 4 is another schematic view showing the topological structure of the superconducting quantum chip. As shown in FIG. 4, the average swap fidelity is 0.894738 based on the topological structure of the superconducting quantum chip and the target error. This average swap fidelity represents that the superconducting quantum chip has excellent connectivity for the design of the quantum circuit and the operation of the quantum algorithm.

In the designing of the quantum circuit, when Q₇ needs to be mapped to Q₈ and the quantity of swap gates to be used is simply taken into consideration, at least five exchanging operations need to be performed. At this time, two different swapping paths may be taken into consideration, i.e., mapping Q₇ to Q₅ or mapping Q₇ to Q₁₁.

A swap fidelity for mapping Q₇ to Q₅ is 0.837989, while a fidelity for mapping Q₇ to Q₁₁ is far smaller than the above-mentioned swap fidelity. Through the introduction of the swap fidelity, it is able to output the swapping path with higher swap fidelity than others. Due to a too large error introduced by the swapping operation, the mapping of Q₇ to Q₁₁ is not selected, i.e., an optimum swapping path for mapping Q₇ to Q₈ is [7,4,1,2,3,5,8].

Hence, the quantum states of different physical quantum bits on the quantum chip are exchanged in accordance with the optimum swapping path [7,4,1,2,3,5,8], so as to map the logic quantum bit to the physical quantum bit to obtain the quantum circuit. The quantum circuit is a logic quantum circuit, so it is able for the outputted optimum swapping path to provide guidance on the implementation of the quantum algorithm on the quantum chip, thereby to improve the operation accuracy of the quantum algorithm.

In a possible embodiment of the present disclosure, Step S102 specifically includes, in the case that the first swap fidelity is greater than or equal to a predetermined threshold, performing the quantum circuit processing on the quantum chip.

In the embodiments of the present disclosure, when the first swap fidelity is greater than or equal to the predetermined threshold, it means that the quantum chip has an ability of executing the quantum algorithm with a small error. Correspondingly, the design of the quantum circuit and the operation of the quantum algorithm may be performed on the quantum chip.

In addition, when the first swap fidelity is smaller than the predetermined threshold, the quantum chip may be re-designed so as to modify a hardware structure of the quantum chip, thereby to improve the connectivity of the quantum chip.

The predetermined threshold may be set according to the practical need. For example, when the quantum circuit has a complex structure or the design accuracy of the quantum circuit is highly demanded, usually the quantum chip needs to be provided with better connectivity. At this time, the predetermined threshold is provided with a larger value, so as to provide the quantum chip with an ability of executing the quantum algorithm with a small error.

In the embodiments of the present disclosure, in the case that the first swap fidelity is greater than or equal to the predetermined threshold, the quantum circuit processing is performed on the quantum chip, so as to ensure the operation accuracy of the quantum algorithm.

### Second Embodiment

As shown in FIG. 5, the present disclosure provides in this embodiment a quantum circuit processing device 500 on a quantum chip, which includes: a first obtaining module 501 configured to obtain a first swap fidelity for measuring connectivity of the quantum chip, the first swap fidelity being determined in accordance with first information, the first information being used to represent a topological structure of the quantum chip, the topological structure indicating that the quantum chip includes at least two physical quantum bits, the first swap fidelity being used to represent an average state maintenance level of logic quantum bits obtained through analog exchanging quantum states of any two of the physical quantum bits; and a circuit processing module 502 configured to perform quantum circuit processing on the quantum chip in accordance with the first swap fidelity.

In a possible embodiment of the present disclosure, the first obtaining module 501 includes: an obtaining sub-module configured to obtain the first information; a determination sub-module configured to determine each second swap fidelity of a first swapping path for quantum states of every two physical quantum bits in accordance with the first information, the first swapping path being a swapping path with a maximum swap fidelity in swapping paths for quantum states of two physical quantum bits, each second swap fidelity being used to represent a state maintenance level of a logic quantum bit obtained through analog exchanging the quantum states of the two physical quantum bits in accordance with the first swapping path; and an averaging sub-module configured to average the second swap fidelities to obtain the first swap fidelity.

In a possible embodiment of the present disclosure, the determination sub-module includes: an obtaining unit configured to obtain second information, the second information including a target error of a first double-bit quantum gate between every two adjacent physical quantum bits; and a determination unit configured to determine the second swap fidelity in accordance with the first information and the second information.

In a possible embodiment of the present disclosure, the determination unit is specifically configured to: obtain a first set and a second set, the first set including a physical quantum bit as a start node of a swapping path, the physical quantum bit as the start node being any physical quantum bit in at least two physical quantum bits, the second set including physical quantum bits in the at least two physical quantum bits other than the first set; select each physical quantum bit in the second set adjacent to a first physical quantum bit in accordance with the topological structure, the first physical quantum bit being a physical quantum bit in the first set; calculate first weights between the first physical quantum bit and the adjacent physical quantum bits in accordance with the target error; and determine the second swap fidelity of the first swapping path for the quantum states of the physical quantum bit as the start node to a second physical quantum bit in accordance with a second weight, the second weight being a minimum weight of the first weights, the second physical quantum bit being a physical quantum bit corresponding to the second weight.

In a possible embodiment of the present disclosure, the determination unit is further configured to: remove the second physical quantum bit from the second set; add the second physical quantum bit into the first set; and in the case that the updated second set is not an empty set, determine a second swap fidelity of the first swapping path for quantum states of the physical quantum bit as the start node to a third physical quantum bit in accordance with the topological structure and the target error, the third physical quantum bit being a physical quantum bit in the updated second set.

In a possible embodiment of the present disclosure, the determination unit is specifically configured to: determine third weights of swapping paths for the quantum states of the physical quantum bit as the start node to the second physical quantum bit in accordance with the second weight; and determine a second swap fidelity of the first swapping path in accordance with a fourth weight and a conversion relationship between the first double-bit quantum gate and a swap gate, the fourth weight being a minimum weight of the third weights, the first swapping path being a swapping path corresponding to the fourth weight, the second swap fidelity being in inverse proportion to the fourth weight, the swap gate being used to exchange the quantum states of the two physical quantum bits.

In a possible embodiment of the present disclosure, the quantum circuit processing device further includes a second obtaining module configured to obtain a first swapping path for the quantum states of every two physical quantum bits, and the first swapping path is a swapping path with a maximum swap fidelity in swapping paths for the quantum states of the two physical quantum bits. The circuit processing module 502 is specifically configured to exchange quantum states of different physical quantum bits on the quantum chip in accordance with the first swapping path, so as to map the logic quantum bit to the physical quantum bit to obtain the quantum circuit.

In a possible embodiment of the present disclosure, the circuit processing module 502 is specifically configured to, in the case that the first swap fidelity is greater than or equal to a predetermined threshold, perform the quantum circuit processing on the quantum chip.

The quantum circuit processing device 500 on the quantum chip is used to implement the above-mentioned quantum circuit processing method on the quantum chip with a same beneficial effect, which will not be particularly defined herein.

The collection, storage, usage, processing, transmission, supply and publication of personal information involved in the embodiments of the present disclosure comply with relevant laws and regulations, and do not violate the principle of the public order.

The present disclosure further provides in some embodiments an electronic device, a computer-readable storage medium and a computer program product.

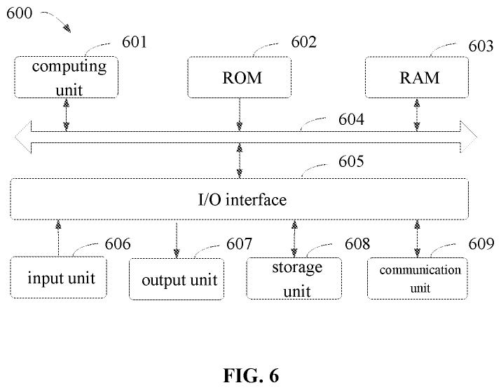

FIG. 6 is a schematic block diagram of an exemplary electronic device 600 in which embodiments of the present disclosure may be implemented. The electronic device is intended to represent all kinds of digital computers, such as a laptop computer, a desktop computer, a work station, a personal digital assistant, a server, a blade server, a main frame or other suitable computers. The electronic device may also represent all kinds of mobile devices, such as a personal digital assistant, a cell phone, a smart phone, a wearable device and other similar computing devices. The components shown here, their connections and relationships, and their functions, are meant to be exemplary only, and are not meant to limit implementations of the present disclosure described and/or claimed herein.

As shown in FIG. 6, the electronic device 600 includes a computing unit 601 configured to execute various processings in accordance with computer programs stored in a Read Only Memory (ROM) 602 or computer programs loaded into a Random Access Memory (RAM) 603 via a storage unit 608. Various programs and data desired for the operation of the electronic device 600 may also be stored in the RAM 603. The computing unit 601, the ROM 602 and the RAM 603 may be connected to each other via a bus 604. In addition, an input/output (I/O) interface 605 may also be connected to the bus 604.

Multiple components in the electronic device 600 are connected to the I/O interface 605. The multiple components include: an input unit 606, e.g., a keyboard, a mouse and the like; an output unit 607, e.g., a variety of displays, loudspeakers, and the like; a storage unit 608, e.g., a magnetic disk, an optic disk and the like; and a communication unit 609, e.g., a network card, a modem, a wireless transceiver, and the like. The communication unit 609 allows the electronic device 600 to exchange information/data with other devices through a computer network and/or other telecommunication networks, such as the Internet.

The computing unit 601 may be any general purpose and/or special purpose processing components having a processing and computing capability. Some examples of the computing unit 601 include, but are not limited to: a central processing unit (CPU), a graphic processing unit (GPU), various special purpose artificial intelligence (AI) computing chips, various computing units running a machine learning model algorithm, a digital signal processor (DSP), and any suitable processor, controller, microcontroller, etc. The computing unit 601 carries out the aforementioned methods and processes, e.g., the quantum circuit processing method on the quantum chip. For example, in some embodiments of the present disclosure, the quantum circuit processing method on the quantum chip may be implemented as a computer software program tangibly embodied in a machine readable medium such as the storage unit 608. In some embodiments of the present disclosure, all or a part of the computer program may be loaded and/or installed on the electronic device 600 through the ROM 602 and/or the communication unit 609. When the computer program is loaded into the RAM 603 and executed by the computing unit 601, one or more steps of the foregoing quantum circuit processing method on the quantum chip may be implemented. Optionally, in some other embodiments of the present disclosure, the computing unit 601 may be configured in any other suitable manner (e.g., by means of firmware) to implement the quantum circuit processing method on the quantum chip.

Various implementations of the aforementioned systems and techniques may be implemented in a digital electronic circuit system, an integrated circuit system, a field-programmable gate array (FPGA), an application specific integrated circuit (ASIC), an application specific standard product (ASSP), a system on a chip (SOC), a complex programmable logic device (CPLD), computer hardware, firmware, software, and/or a combination thereof. The various implementations may include an implementation in form of one or more computer programs. The one or more computer programs may be executed and/or interpreted on a programmable system including at least one programmable processor. The programmable processor may be a special purpose or general purpose programmable processor, may receive data and instructions from a storage system, at least one input device and at least one output device, and may transmit data and instructions to the storage system, the at least one input device and the at least one output device.

Program codes for implementing the methods of the present disclosure may be written in one programming language or any combination of multiple programming languages. These program codes may be provided to a processor or controller of a general purpose computer, a special purpose computer, or other programmable data processing device, such that the functions/operations specified in the flow diagram and/or block diagram are implemented when the program codes are executed by the processor or controller. The program codes may be run entirely on a machine, run partially on the machine, run partially on the machine and partially on a remote machine as a standalone software package, or run entirely on the remote machine or server.

In the context of the present disclosure, the machine readable medium may be a tangible medium, and may include or store a program used by an instruction execution system, device or apparatus, or a program used in conjunction with the instruction execution system, device or apparatus. The machine readable medium may be a machine readable signal medium or a machine readable storage medium. The machine readable medium includes, but is not limited to: an electronic, magnetic, optical, electromagnetic, infrared, or semiconductor system, device or apparatus, or any suitable combination thereof. A more specific example of the machine readable storage medium includes: an electrical connection based on one or more wires, a portable computer disk, a hard disk, a random access memory (RAM), a read only memory (ROM), an erasable programmable read only memory (EPROM or flash memory), an optic fiber, a portable compact disc read only memory (CD-ROM), an optical storage device, a magnetic storage device, or any suitable combination thereof.

To facilitate user interaction, the system and technique described herein may be implemented on a computer. The computer is provided with a display device (for example, a cathode ray tube (CRT) or liquid crystal display (LCD) monitor) for displaying information to a user, a keyboard and a pointing device (for example, a mouse or a track ball). The user may provide an input to the computer through the keyboard and the pointing device. Other kinds of devices may be provided for user interaction, for example, a feedback provided to the user may be any manner of sensory feedback (e.g., visual feedback, auditory feedback, or tactile feedback); and input from the user may be received by any means (including sound input, voice input, or tactile input).

The system and technique described herein may be implemented in a computing system that includes a back-end component (e.g., as a data server), or that includes a middle-ware component (e.g., an application server), or that includes a front-end component (e.g., a client computer having a graphical user interface or a Web browser through which a user can interact with an implementation of the system and technique), or any combination of such back-end, middleware, or front-end components. The components of the system can be interconnected by any form or medium of digital data communication (e.g., a communication network). Examples of communication networks include a local area network (LAN), a wide area network (WAN) and the Internet.

The computer system can include a client and a server. The client and server are generally remote from each other and typically interact through a communication network. The relationship of client and server arises by virtue of computer programs running on respective computers and having a client-server relationship to each other. The server may be a cloud server, a server of a distributed system, or a server combined with blockchain.

It should be appreciated that, all forms of processes shown above may be used, and steps thereof may be reordered, added or deleted. For example, as long as expected results of the technical solutions of the present disclosure can be achieved, steps set forth in the present disclosure may be performed in parallel, performed sequentially, or performed in a different order, and there is no limitation in this regard.

The foregoing specific implementations constitute no limitation on the scope of the present disclosure. It is appreciated by those skilled in the art, various modifications, combinations, sub-combinations and replacements may be made according to design requirements and other factors. Any modifications, equivalent replacements and improvements made without deviating from the spirit and principle of the present disclosure shall be deemed as falling within the scope of the present disclosure.

What is claimed is:

1. A quantum circuit processing method on a quantum chip, comprising:
obtaining a first swap fidelity for measuring connectivity of the quantum chip, the first swap fidelity being determined in accordance with first information, the first information being used to represent a topological structure of the quantum chip, the topological structure indicating that the quantum chip comprises at least two physical quantum bits, the first swap fidelity being used to represent an average state maintenance level of logic quantum bits obtained through analog exchanging quantum states of any two of the physical quantum bits; and
performing quantum circuit processing on the quantum chip in accordance with the first swap fidelity.

2. The quantum circuit processing method according to claim 1, wherein obtaining the first swap fidelity for measuring the connectivity of the quantum chip comprises:
obtaining the first information;
determining each second swap fidelity of a first swapping path for quantum states of every two physical quantum bits in accordance with the first information, the first swapping path being a swapping path with a maximum swap fidelity in swapping paths for quantum states of two physical quantum bits, each second swap fidelity being used to represent a state maintenance level of a logic quantum bit obtained through analog exchanging the quantum states of the two physical quantum bits in accordance with the first swapping path; and
averaging the second swap fidelities to obtain the first swap fidelity.

3. The quantum circuit processing method according to claim 2, wherein determining each second swap fidelity of the first swapping path for the quantum states of every two physical quantum bits in accordance with the first information comprises:
obtaining second information, the second information comprising a target error of a first double-bit quantum gate between every two adjacent physical quantum bits; and
determining the second swap fidelity in accordance with the first information and the second information.

4. The quantum circuit processing method according to claim 3, wherein determining the second swap fidelity in accordance with the first information and the second information comprises:
obtaining a first set and a second set, the first set comprising a physical quantum bit as a start node of a swapping path, the physical quantum bit as the start node being any physical quantum bit in at least two physical quantum bits, the second set comprising physical quantum bits in the at least two physical quantum bits other than the first set;
selecting each physical quantum bit in the second set adjacent to a first physical quantum bit in accordance with the topological structure, the first physical quantum bit being a physical quantum bit in the first set;
calculating first weights between the first physical quantum bit and the adjacent physical quantum bits in accordance with the target error; and
determining the second swap fidelity of the first swapping path for the quantum states of the physical quantum bit as the start node to a second physical quantum bit in accordance with a second weight, the second weight being a minimum weight of the first weights, the second physical quantum bit being a physical quantum bit corresponding to the second weight.

5. The quantum circuit processing method according to claim 4, wherein determining the second swap fidelity in accordance with the first information and the second information further comprises:
removing the second physical quantum bit from the second set;
adding the second physical quantum bit into the first set; and
in the case that the updated second set is not an empty set, determining a second swap fidelity of the first swapping path for quantum states of the physical quantum bit as the start node to a third physical quantum bit in accordance with the topological structure and the target error, the third physical quantum bit being a physical quantum bit in the updated second set.

6. The quantum circuit processing method according to claim 4, wherein determining the second swap fidelity of the first swapping path for the quantum states of the physical quantum bit as the start node to the second physical quantum bit in accordance with the second weight comprises:
determining third weights of swapping paths for the quantum states of the physical quantum bit as the start node to the second physical quantum bit in accordance with the second weight; and
determining a second swap fidelity of the first swapping path in accordance with a fourth weight and a conversion relationship between the first double-bit quantum gate and a swap gate, the fourth weight being a minimum weight of the third weights, the first swapping path being a swapping path corresponding to the fourth weight, the second swap fidelity being in inverse proportion to the fourth weight, and the swap gate being used to exchange the quantum states of the two physical quantum bits.

7. The quantum circuit processing method according to claim 1, further comprising:
obtaining a first swapping path for the quantum states of every two physical quantum bits, each first swapping path comprising a swapping path with a maximum swap fidelity in swapping paths for the quantum states of each two physical quantum bits,
wherein performing the quantum circuit processing on the quantum chip comprises exchanging quantum states of different physical quantum bits on the quantum chip in accordance with a corresponding first swapping path, so as to map the logic quantum bit to the physical quantum bit to obtain the quantum circuit.

8. The quantum circuit processing method according to claim 1, wherein performing the quantum circuit processing on the quantum chip in accordance with the first swap fidelity comprises:
in the case that the first swap fidelity is greater than or equal to a predetermined threshold, performing the quantum circuit processing on the quantum chip.

9. An electronic device, comprising at least one processor, and a memory in communication with the at least one processor and storing therein instructions executed by the at least one processor, wherein the instructions are executed by the at least one processor so as to implement a quantum circuit processing method on a quantum chip, the quantum circuit processing method comprising:
obtaining a first swap fidelity for measuring connectivity of the quantum chip, the first swap fidelity being determined in accordance with first information, the first information being used to represent a topological structure of the quantum chip, the topological structure indicating that the quantum chip comprises at least two physical quantum bits, the first swap fidelity being used to represent an average state maintenance level of logic quantum bits obtained through analog exchanging quantum states of any two of the physical quantum bits; and
performing quantum circuit processing on the quantum chip in accordance with the first swap fidelity.

10. The electronic device according to claim 9, wherein obtaining the first swap fidelity for measuring the connectivity of the quantum chip comprises:
obtaining the first information;
determining each second swap fidelity of a first swapping path for quantum states of every two physical quantum bits in accordance with the first information, the first swapping path being a swapping path with a maximum swap fidelity in swapping paths for quantum states of two physical quantum bits, each second swap fidelity being used to represent a state maintenance level of a logic quantum bit obtained through analog exchanging the quantum states of the two physical quantum bits in accordance with the first swapping path; and
averaging the second swap fidelities to obtain the first swap fidelity.

11. The electronic device according to claim 10, wherein determining each second swap fidelity of the first swapping path for the quantum states of every two physical quantum bits in accordance with the first information comprises:
obtaining second information, the second information comprising a target error of a first double-bit quantum gate between every two adjacent physical quantum bits; and
determining the second swap fidelity in accordance with the first information and the second information.

12. The electronic device according to claim 11, wherein determining the second swap fidelity in accordance with the first information and the second information comprises:
obtaining a first set and a second set, the first set comprising a physical quantum bit as a start node of a swapping path, the physical quantum bit as the start node being any physical quantum bit in at least two physical quantum bits, the second set comprising physical quantum bits in the at least two physical quantum bits other than the first set;
selecting each physical quantum bit in the second set adjacent to a first physical quantum bit in accordance with the topological structure, the first physical quantum bit being a physical quantum bit in the first set;
calculating first weights between the first physical quantum bit and the adjacent physical quantum bits in accordance with the target error; and
determining the second swap fidelity of the first swapping path for the quantum states of the physical quantum bit as the start node to a second physical quantum bit in accordance with a second weight, the second weight being a minimum weight of the first weights, the second physical quantum bit being a physical quantum bit corresponding to the second weight.

13. The electronic device according to claim 12, wherein determining the second swap fidelity in accordance with the first information and the second information further comprises:
removing the second physical quantum bit from the second set;
adding the second physical quantum bit into the first set; and
in the case that the updated second set is not an empty set, determining a second swap fidelity of the first swapping path for quantum states of the physical quantum bit as the start node to a third physical quantum bit in accordance with the topological structure and the target error, the third physical quantum bit being a physical quantum bit in the updated second set.

14. The electronic device according to claim 12, wherein determining the second swap fidelity of the first swapping path for the quantum states of the physical quantum bit as the start node to the second physical quantum bit in accordance with the second weight comprises:
determining third weights of swapping paths for the quantum states of the physical quantum bit as the start node to the second physical quantum bit in accordance with the second weight; and
determining a second swap fidelity of the first swapping path in accordance with a fourth weight and a conversion relationship between the first double-bit quantum gate and a swap gate, the fourth weight being a minimum weight of the third weights, the first swapping path being a swapping path corresponding to the fourth weight, the second swap fidelity being in inverse proportion to the fourth weight, the swap gate being used to exchange the quantum states of the two physical quantum bits.

15. The electronic device according to claim 9, wherein the quantum circuit processing method further comprises:
obtaining a first swapping path for the quantum states of every two physical quantum bits, and each first swapping path being a swapping path with a maximum swap fidelity in swapping paths for the quantum states of the corresponding two physical quantum bits,
wherein the performing the quantum circuit processing on the quantum chip comprises exchanging quantum states of different physical quantum bits on the quantum chip in accordance with the first swapping path, so as to map the logic quantum bit to the physical quantum bit to obtain the quantum circuit.

16. The electronic device according to claim 9, wherein performing the quantum circuit processing on the quantum chip in accordance with the first swap fidelity comprises:
in the case that the first swap fidelity is greater than or equal to a predetermined threshold, performing the quantum circuit processing on the quantum chip.

17. A non-transitory computer-readable storage medium storing therein one or more computer instructions, wherein the one or more computer instructions are executed by a computer so as to implement a quantum circuit processing method on a quantum chip, the quantum circuit processing method comprising:
obtaining a first swap fidelity for measuring connectivity of the quantum chip, the first swap fidelity being determined in accordance with first information, the first information being used to represent a topological structure of the quantum chip, the topological structure indicating that the quantum chip comprises at least two physical quantum bits, the first swap fidelity being used to represent an average state maintenance level of logic quantum bits obtained through analog exchanging quantum states of any two of the physical quantum bits; and
performing quantum circuit processing on the quantum chip in accordance with the first swap fidelity.

18. The non-transitory computer-readable storage medium according to claim 17, wherein the obtaining the first swap fidelity for measuring the connectivity of the quantum chip comprises:
obtaining the first information;
determining each second swap fidelity of a first swapping path for quantum states of every two physical quantum bits in accordance with the first information, the first swapping path being a swapping path with a maximum swap fidelity in swapping paths for quantum states of two physical quantum bits, each second swap fidelity being used to represent a state maintenance level of a logic quantum bit obtained through analog exchanging the quantum states of the two physical quantum bits in accordance with the first swapping path; and
averaging the second swap fidelities to obtain the first swap fidelity.

19. The non-transitory computer-readable storage medium according to claim 18, wherein the determining each second swap fidelity of the first swapping path for the quantum states of every two physical quantum bits in accordance with the first information comprises:
obtaining second information, the second information comprising a target error of a first double-bit quantum gate between every two adjacent physical quantum bits; and
determining the second swap fidelity in accordance with the first information and the second information.

20. The non-transitory computer-readable storage medium according to claim 19, wherein the determining the second swap fidelity in accordance with the first information and the second information comprises:
obtaining a first set and a second set, the first set comprising a physical quantum bit as a start node of a swapping path, the physical quantum bit as the start node being any physical quantum bit in at least two physical quantum bits, the second set comprising physical quantum bits in the at least two physical quantum bits other than the first set;
selecting each physical quantum bit in the second set adjacent to a first physical quantum bit in accordance with the topological structure, the first physical quantum bit being a physical quantum bit in the first set;
calculating first weights between the first physical quantum bit and the adjacent physical quantum bits in accordance with the target error; and
determining the second swap fidelity of the first swapping path for the quantum states of the physical quantum bit as the start node to a second physical quantum bit in accordance with a second weight, the second weight being a minimum weight of the first weights, the second physical quantum bit being a physical quantum bit corresponding to the second weight.
